(19) United States
(12) Patent Application Publication
(10) Pub. No.: US 2022/0095524 A1
(43) Pub. Date: Mar. 31, 2022

(54) AUTOMATIC WALKING GARDEN TRIMMER

(71) Applicant: KI LAI NG, HONG KONG (CN)

(72) Inventor: KI LAI NG, HONG KONG (CN)

(21) Appl. No.: 17/039,990

(22) Filed: Sep. 30, 2020

(51) Int. Cl. A01B 63/00; B25J 5/00; B25J 9/14; A01B 69/00; B25J 9/06; A01D 69/02; A01D 69/03

(52) U.S. Cl. CPC A01B 63/008; B25J 5/007; B25J 9/144; A01D 69/03; A01B 63/004; B25J 9/06; A01D 69/02; A01B 69/00

(57) ABSTRACT

The invention relates to an automatic walking garden trimmer, which includes a power locomotive and a trimming device, the power locomotive is rotatably connected with a turntable support which is driven by the power device to rotate horizontally; a lower supporting arm and a base cylinder for driving the lower supporting arm to swing are hinged to the turntable support; at least two overhanging arms and an extension cylinder for driving the overhanging arms to swing and adjusting an overhanging distance are hinged to an end of the lower supporting arm, and a sphere is connected to the connecting seat; two groups of trimming devices are arranged on side surfaces of the sphere, the trimming device includes a spiral device and a trimming ring, the spiral device includes a spiral bracket on which a sleeve is disposed on. A rotary blade of the trimming device can be replaced.

### TECHNICAL FIELD

The invention relates to a field of garden mechanical equipment, in particular to an automatic walking garden trimmer.

### BACKGROUND ART

Currently, there are greenbelts on both sides of an urban road or an expressway, such as holly with an equal height, small green trees with various shapes and other greenbelts planted on both sides of a road, green trees planted in a median provided in a middle of the expressway, and green trees provided on both sides of the expressway. Most of pruning of a garden greenbelt is done manually by an ordinary hand-held trimmer, which is labor intensive and inefficient; and because the trimmer itself has a certain weight and further it is more difficult to prune the greenbelt at a high place and a side, which is intensive in work, when such an operation is made for a long time, it often tends to cause a low work efficiency and physical fatigue; and in addition, the green trees in a middle or both sides of an expressway are not easy to be pruned for their large heights and needing a manual climbing, which not only presents a low labor efficiency but also brings some potential safety hazard.

In addition, the existing trimmer presents a low mechanical efficiency and is with a single pruning style, which can not meet requirements of the garden pruning, is not simple enough, time-consuming and laborious to operate and is inefficient; in addition, the trimming device may cause an unstable pruning and an unaesthetical style due to a driving by a motor during its use; and the existing device is fixed and irreplaceable for a portion of a cutter head, which leads to only one type of trees or flowers and plants being pruned, and thus is with a single pruning effect, and thicknesses and hardnesses of different trees are different and thus will cause a serious damage to the blade. Therefore, in view of shortcomings existing in the prior art, it is necessary to provide a novel device.

### SUMMARY

In view of shortcomings existing in the prior art, an object of the present invention is to provide an automatic walking garden trimmer which is able to automatically prune greenbelts on both sides of a road and with a high efficiency, so as to solve the shortcomings of a low mechanical efficiency, a high working intensity, a low working efficiency, a single pruning style, an unattractive appearance and others of a trimmer in the prior art.

An automatic walking garden trimmer includes a power locomotive, a trimming device and a controller, the power locomotive being rotatably connected with a turntable support which is driven by a power device to rotate horizontally, a lower supporting arm and a base cylinder for driving the lower supporting arm to swing being hinged to the turntable support, at least two overhanging arms and an extension cylinder for driving the overhanging arms to swing and adjusting an overhanging distance being hinged to an end of the lower supporting arm, an end of the overhanging arm being rotatably connected with a connecting seat and a rotary power device for driving the connecting seat to rotate, a plane formed by a rotating track of the connecting seat being parallel or coincident with a plane formed by a swinging track of the overhanging arm, and a sphere being connected to the connecting seat;

two groups of the trimming devices being arranged on side surfaces of the sphere, the trimming device including a spiral device and a trimming ring, the spiral device including a spiral bracket and a sleeve disposed on the spiral bracket, lengths of the sleeves for the two groups of trimming devices being different, the sleeves being sequentially provided with two rows of first telescopic rods, second telescopic rods and third telescopic rods from inside to outside through a hydraulic cylinder, a push rod being provided at an outer end of the third telescopic rod with a tension spring with a high hardness being provided at the outer end of the push rod, a hook being provided at an outer end of the tension spring, the trimming ring including a plurality of metal frames, and pin shaft mounting holes being defined at both ends and a midpoint of each metal frame, the pin shaft mounting holes in middle parts of every two metal frames overlapping and being installed into an X-shaped cross movable members through a pin shaft, ends of opposite sides of every two X-shaped cross movable members being connected by the pin shaft, a plurality of X-shaped cross movable members being connected into an annular telescopic trimming ring, with two hooks being respectively fixedly connected with two metal frames of one of the X-shaped cross movable members on the trimming ring;

A micromotor is mounted below connecting pin shafts of every two X-shaped cross movable members in the trimming ring, and a detachable rotating blade is mounted on an output shaft of the micromotor,

The power device, the base cylinder, the micromotor, the extension cylinder and the rotary power device being all control by the controller.

Preferably, a radius of the trimming ring in a fully extended state is three times than that in a fully contracted state.

In a more preferred embodiment, a maximum length of the rotating blade is not more than half a length of the metal frame.

In a more preferred embodiment, each of the two groups of trimming devices is arranged to form an angle between 110° to 180° with a shaft in the middle of the sphere.

In a more preferred embodiment, a rear end and a piston rod end of the extension cylinder are respectively hinged at a front part of a front one of two adjacent overhanging arms and a middle forward part of the rear one of the two adjacent overhanging arms.

In a more preferred embodiment, the connecting seat is rotatably connected to a rotating shaft at an overhanging end of the overhanging arm, and the rotary power device includes a rotary gearbox which is connected to the overhanging arm and is in power connection with a servo drive motor, a worm segment is arranged on a power output shaft of the rotary gearbox, and a power worm gear meshed with the worm segment is provided on the rotating shaft.

In a more preferred embodiment, the rotary power device includes a connecting rod fixedly connected to the connecting seat, the connecting rod is hinged with the overhanging end of the overhanging arm through a hinge shaft, the overhanging arm is hinged with a pulling cylinder, and a piston rod of the pulling cylinder is hinged with the connecting seat.

In a more preferred embodiment, the turntable support is rotatably connected to a main rotating shaft of a rear support seat of the power locomotive, and the power device includes a main gearbox connected to the rear support seat and driven by a main driving motor, a worm segment is provided on a power output shaft of the main gearbox, and a worm gear meshed with the worm segment is arranged on the main rotating shaft.

In a more preferred embodiment, the rear support seat is provided with a brake plate which is driven by an electric push rod and can abut against the turntable support, and the electric push rod and the main driving motor are controlled by the controller.

In a more preferred embodiment, the controller adopts a PLC controller for an automatic control.

Compared with the prior art, the invention has the following beneficial effects:

The rotary blade of the trimming device can be replaced, and operators can select a suitable blade for operation according to different shapes and sizes of branches to be pruned, so that the device has a wider application range and strong practicability, and a new blade can be replaced once the blade is damaged, thus saving maintenance time and improving work efficiency;

According to the invention, two groups of trimming devices are arranged, which is with a high stability; the trimming device include a spiral bracket, which presents a higher strength; in addition, the spiral bracket structure greatly reduces vibration from a constructor during operations so that the device is more stable; by arranging the first telescopic rod, the second telescopic rod, the third telescopic rod, the push rod and the tension spring, an expansion/contraction ratio can be greatly improved; and with sleeves of different lengths arranged, different sleeves can be selected according to heights of different branches by adjusting the rotating shaft, and different rotating blades can be replaced according to thicknesses of different branches, so as to realize a better pruning of the branches.

According to the invention, greening plants on both sides of an urban road or an expressway can be automatically pruned through the above mechanism, with advantages of high labor efficiency and large pruning range.

### BRIEF DESCRIPTION OF DRAWINGS

The invention will be further explained with reference to drawings and examples.

FIG. 1 is a structural schematic diagram according to the present invention;

FIG. 2 is a structural schematic diagram along the B direction in FIG. 1;

FIG. 3 is a schematic structural view taken along line D-D in FIG. 2;

FIG. 4 is a structural diagram of an embodiment in FIG. 1 in a use state;

FIG. 5 is a schematic structural diagram of another embodiment of the present invention;

FIG. 6 is a structural schematic diagram of a trimming ring in a contracted state according to the present invention;

FIG. 7 is a structural schematic diagram of the trimming ring in an extended state according to the present invention;

FIG. 8 is a schematic structural diagram of a trimming ring according to the present invention;

FIG. 9 shows different shapes of a rotating blade according to the present invention;

FIG. 10 is a state diagram showing an extension within the sleeve according to the present invention;

FIG. 11 is a state diagram of a contraction within the sleeve according to the present invention; and

FIG. 12 is an enlarged view of the trimming device at “C” in FIG. 1.

Reference numbers in the figures are respectively shown as follows: 1. Power Locomotive, 2. Turntable Support, 3. Lower Supporting Arm, 4. Base Cylinder, 5. Overhanging Arm, 6. Extension Cylinder, 7. Connecting Seat, 8. Connecting Rod, 9. Pulling Cylinder, 10. Main Drive Motor, 11. Main Gearbox, 12. Brake Plates, 17. Power Output Shaft, 18. Trimming Device, 19. Sphere, 20. Spiral Device, 21. Spiral Bracket, 22. Sleeve, 23. First Telescopic Rod, 24, Second Telescopic Rod, 25, Third Telescopic Rod, 26. Push Rod, 27. Tension Spring, 28. Hook, 29. Trimming Ring, 30. Metal Frame, 31. Pin Shaft, 32. Micromotor, 33. Rotating Blade, 34. Electric Push Rod.

### DETAILED DESCRIPTION OF PREFERRED EMBODIMENTS

In order to make the objects, technical schemes and advantages of the present invention more clear, the present invention will be further described in detail with reference to the drawings and examples. It should be understood that the specific embodiments described herein are only used to explain the present invention, and are not intended to limit the present invention.

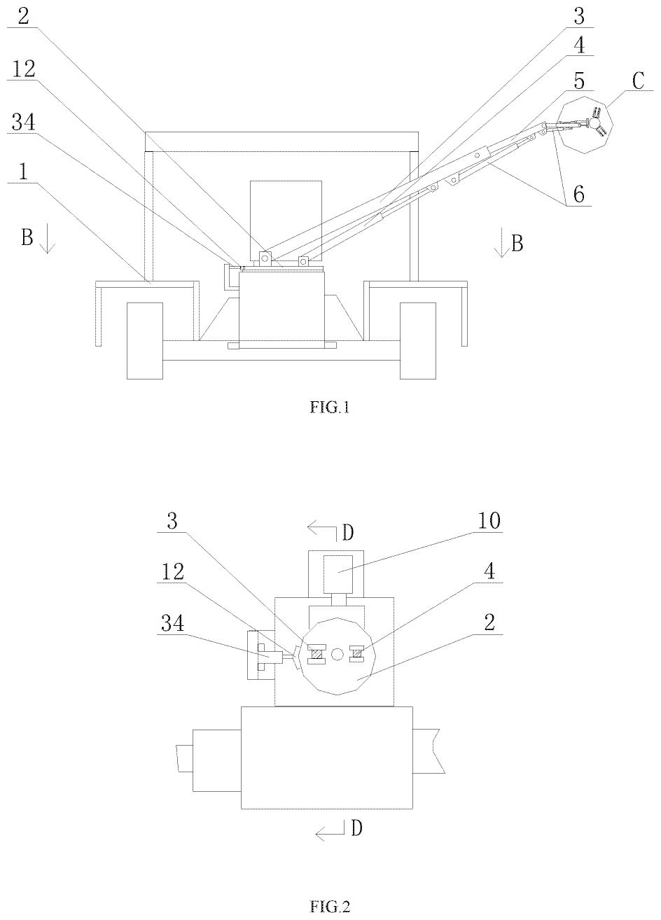

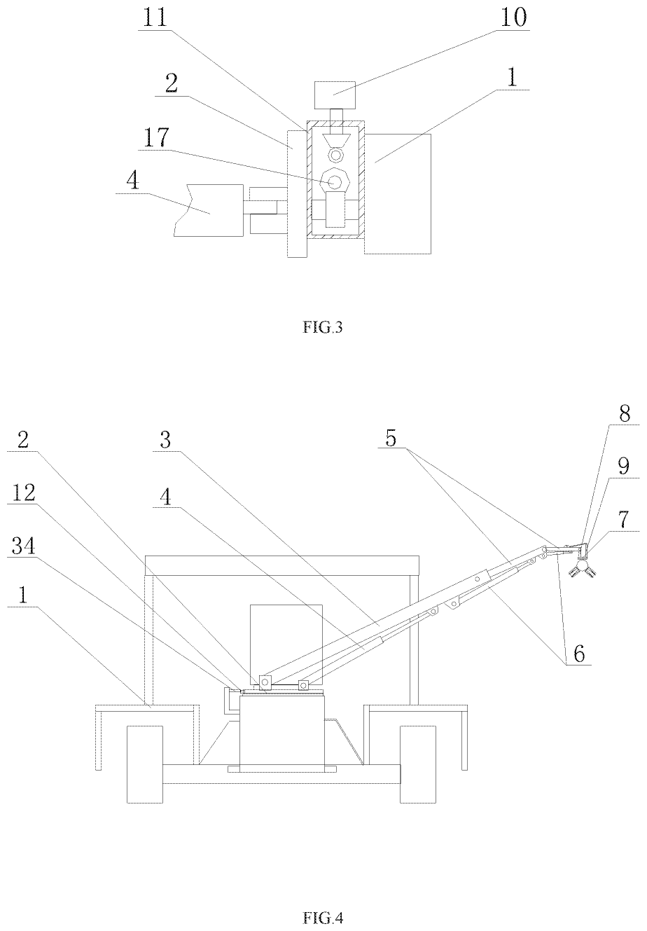

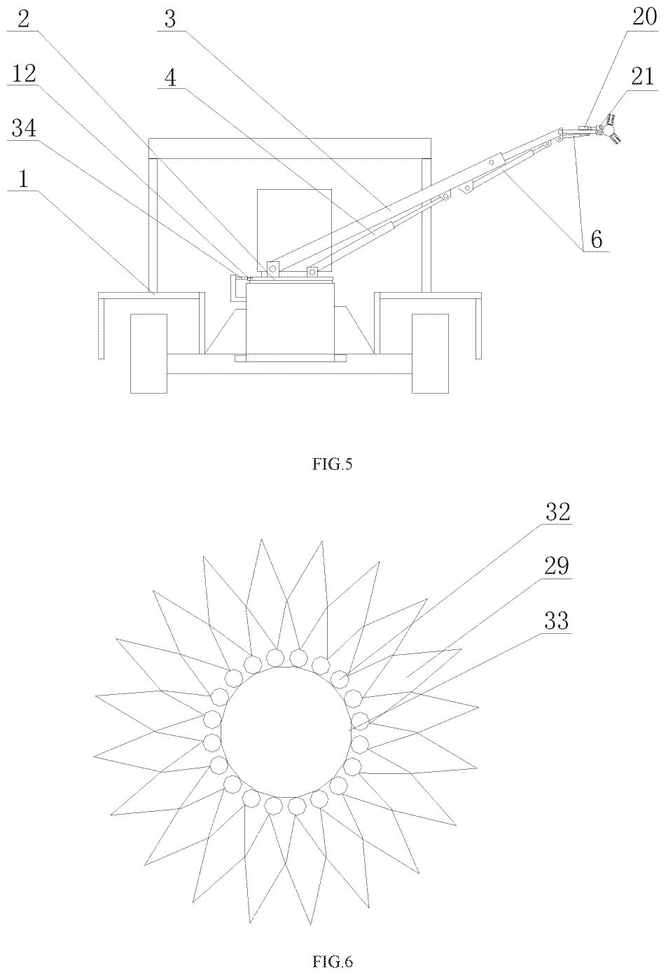

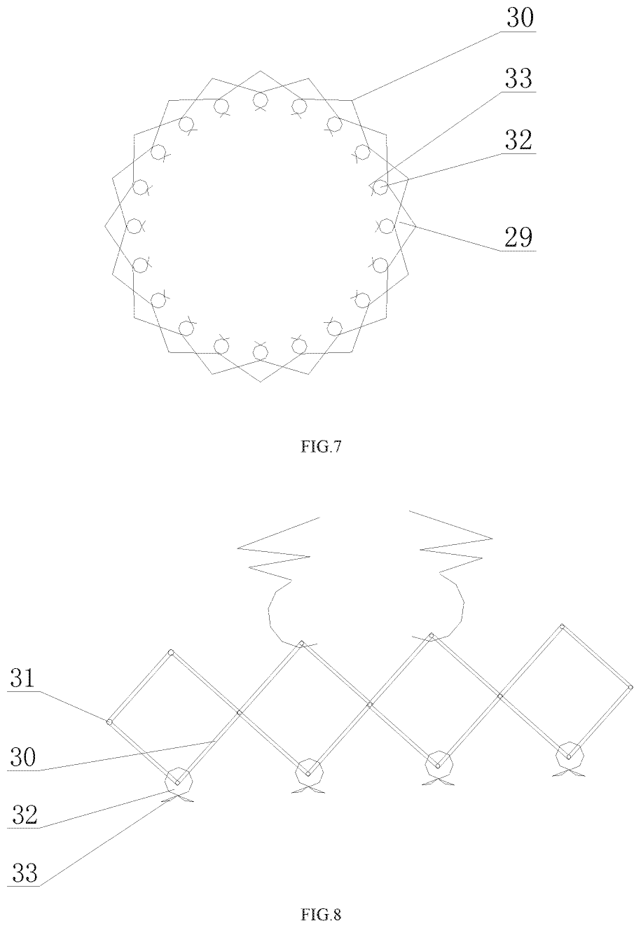

As shown in FIGS. 1 to 12, an automatic walking garden trimmer includes a power locomotive 1, the power locomotive 1 can be a tractor or other locomotive and its specific walking mechanism, power mechanism and control mechanism are all known in the prior art, which will not repeatedly described here. The power locomotive 1 is rotatably connected with a turntable support 2 which is driven by a power device to rotate horizontally, a lower supporting arm 3 and a base cylinder 4 for driving the lower supporting arm 3 to swing are hinged to the turntable support 2; two overhanging arms 5 and an extension cylinder 6 for driving the overhanging arms to swing and adjusting an overhanging distance are hinged to the lower supporting arm 3. In this embodiment, two overhanging arms 5 are sequentially hinged to an end of the lower supporting arm 3, and a rear end and a piston rod end of the extension cylinder 6 are respectively hinged at a front part of a front one 5 of two adjacent overhanging arms and a middle forward part of the rear one 5 of the two adjacent overhanging arms, the front and the rear means that a position close to the power locomotive is at the rear end of the overhanging arm, the lower supporting arm 3 and the two overhanging arms 5 are in a same plane, and thus an overhanging end of the overhanging arm 5 can be expanded outward by a power driving of the base cylinder 4 and the extension cylinder 6. The end of the overhanging arm 5 is rotatably connected with a connecting seat 7 and a rotary power device for driving the connecting seat 7 to rotate, a plane formed by a rotating track of the connecting seat 7 is parallel or coincident with a plane formed by a swinging track of the overhanging arm 5, and a sphere 19 is connected to the connecting seat 7.

Two groups of the trimming devices 18 are arranged on side surfaces of the sphere 19, each of the two groups of trimming devices 18 is arranged to form an angle between 110° to 180° with a shaft in the middle of the sphere 19, the trimming device 18 includes a spiral device 20 and a trimming ring 29, the spiral device 20 includes a spiral bracket 21 and a sleeve 22 is disposed on the spiral bracket 21, lengths of the sleeves 22 for the two sets of trimming devices 18 are different, two rows of first telescopic rods 23, second telescopic rods 24 and third telescopic rods 25 are sequentially provided in the sleeves 22 from inside to outside through a hydraulic cylinder; a push rod 26 is provided at an outer end of the third telescopic rod 25 with a tension spring 27 with a high hardness being provided at the outer end of the push rod 26, a hook 28 is provided at an outer end of the tension spring 27, and a radius of the trimming ring 29 in a fully extended state is three times than that in a fully contracted state; the trimming ring 29 includes a plurality of metal frames 30, and pin shaft mounting holes are defined at both ends and a midpoint of each metal frame 30, the pin shaft mounting holes in middle parts of every two metal frames 30 overlap and are installed into an X-shaped cross movable members through a pin shaft 31; ends of opposite sides of every two X-shaped cross movable members are connected by the pin shaft 31; a plurality of X-shaped cross movable members are connected into an annular telescopic trimming ring 29, with two hooks 28 being respectively fixedly connected with two metal frames 30 of one of the X-shaped cross movable members on the trimming ring 29; and a micromotor 32 is mounted below connecting pin shafts of every two X-shaped cross movable members in the trimming ring 29, and a detachable rotating blade 33 is mounted on an output shaft of the micromotor 32, and a maximum length of the rotating blade 33 is not more than half a length of the metal frame 30,

the power device, the base cylinder 4, the micromotor 32, the extension cylinder 6 and the rotary power device are all control by a controller. In this embodiment, the PLC controller is used for an automatic control, and its specific control structure can be obtained according to a action process, which is known in the prior art and will not be repeatedly described here.

Preferably, the connecting seat 7 is rotatably connected to a rotating shaft at an overhanging end of the overhanging arm 5, and the rotary power device includes a rotary gearbox which is connected to the overhanging arm 5 and is in power connection with a servo drive motor, a worm segment is arranged on a power output shaft of the rotary gearbox, and a power worm gear meshed with the worm segment is provided on the rotating shaft.

Preferably, the rotary power device includes a connecting rod 8 fixedly connected to the connecting seat 7, the connecting rod is hinged with the overhanging end of the overhanging arm 5 through a hinge shaft, the overhanging arm 5 is hinged with a pulling cylinder 9, and a piston rod of the pulling cylinder 9 is hinged with the connecting seat 7.

Preferably, the turntable support 2 is rotatably connected to a main rotating shaft of a rear support seat of the power locomotive, and the power device includes a main gearbox 11 connected to the rear support seat and driven by a main driving motor 10, a worm segment is provided on a power output shaft of the main gearbox, and a worm gear meshed with the worm segment is provided on the main rotating shaft.

Preferably, a brake plate 12 which is driven by an electric push rod 34 and can abut against the turntable support 2 is provided on the rear support seat, and the electric push rod 34 and the main driving motor 10 are controlled by the controller.

As shown in FIG. 1, in this embodiment, the rotary power device includes a connecting rod 8 fixedly connected to the connecting seat 7, the connecting rod 8 is hinged with the overhanging end of the overhanging arm 5 through a hinge shaft, the overhanging arm 5 is hinged with a pulling cylinder 9, and a piston rod of the pulling cylinder 9 is hinged with the connecting seat 7; and with a pulling action of the pulling cylinder 9, the connecting seat can rotate by a certain angle, that is, an automatic cutting device can be driven to rotate and a cutting angle can be adjusted.

As shown in FIGS. 1, 2 and 3, the turntable support 2 is fixedly connected with a main rotating shaft rotatably connected to the rear support seat of the power locomotive 1, the power device includes a main gearbox 11 connected to the rear support seat and driven by a main driving motor 10, a worm segment is provided on a power output shaft of the main gearbox 11, and a worm gear meshed with the worm segment is provided on the main rotating shaft. A structure of the main gearbox 11 is shown in FIG. 3, a power input of the main drive motor 10 is input into the main gearbox, and then is transmitted to the power output shaft 17 through a power transmission by a bevel gear, an intermediate transmission shaft and a cylindrical gear; the above worm segment is provided on the power output shaft 17, and of course the main gearbox 11 can have other structures, which will not be illustrated one by one. The above structure makes full use of a self-locking property carried in a transmission by the worm gear and shaft, thus ensuring a rotational stability of the turntable support. A brake plate 12 which is driven by an electric push rod 34 and can abut against the turntable support 2 is provided on the rear support seat, the electric push rod and the main driving motor 10 are controlled by the controller, and when the main driving motor 17 drives the turntable support 2 to rotate, the brake plate 12 is driven by the electric push rod 34 to separate from the turntable support, and when the turntable support stops rotating, the brake plate 12 is driven by the electric push rod 34 to abut against the turntable support 2, thus reducing a rotational inertia of the turntable support 2 and ensuring its rotational accuracy and protecting the power drive.

As shown in FIGS. 1 to 11, when the greening plants on a side of the urban road need to be pruned, the power locomotive 1 is operated to run to a roadside of the urban road. The overhanging end of the overhanging arm 5 can be extended towards the outside to be located above, or to a side of, the greening plants through the power driving of the base cylinder 4 and extension cylinder 6, and then the connecting seat 7 is driven to rotate by a certain angle through the power driving of the pulling cylinder 9, so that a cutting fixed knife and a cutting movable knife are at a best cutting angle, and then the greening plants are pruned through a walking of the power locomotive 1. The trimming device 18 includes a spiral device 20 and a trimming ring 29, the spiral device 20 includes a spiral bracket 21, two groups of sleeves 22 are provided on the spiral bracket 21, and lengths of the sleeves 22 of the two groups of trimming devices 18 are different, when high branches need to be pruned, the sphere is rotated to correspond the trimming devices with long sleeves to the branches so as to perform the pruning, and the ones with short sleeves are selected in a reverse situation; when the trimming ring 29 reaches a working position, the PLC controller performs an automatic control to open the X-shaped cross movable members, and when thick branches need to be pruned, the PLC controller performs the automatic control to extend the trimming ring 29 and increase its trimming radius, and on the contrary, when thin branches need to be pruned, a contraction of the trimming ring 29 is made to decrease its trimming radius. After the trimming ring 29 extends or contracts in place, the micromotor is controlled to drive the rotary blade 33 to work. Meanwhile, the rotating blades 33 with different shapes can be replaced according to different shapes of leaves to be pruned, as shown in FIG. 9.

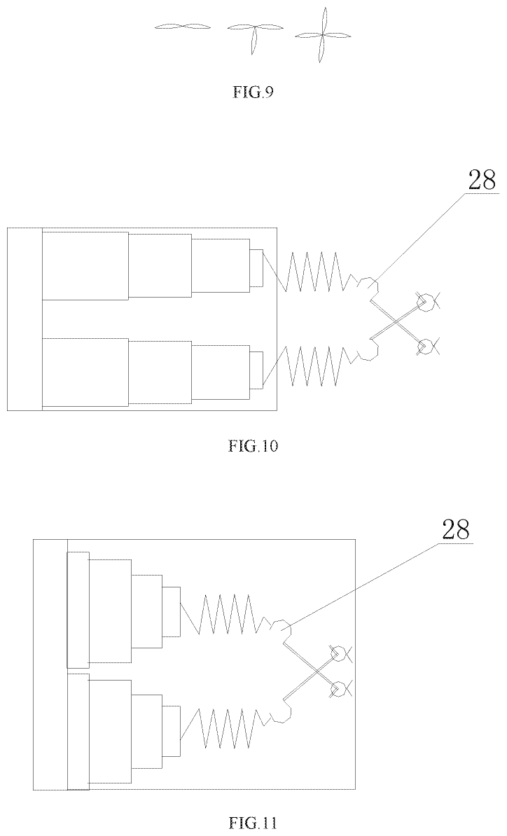

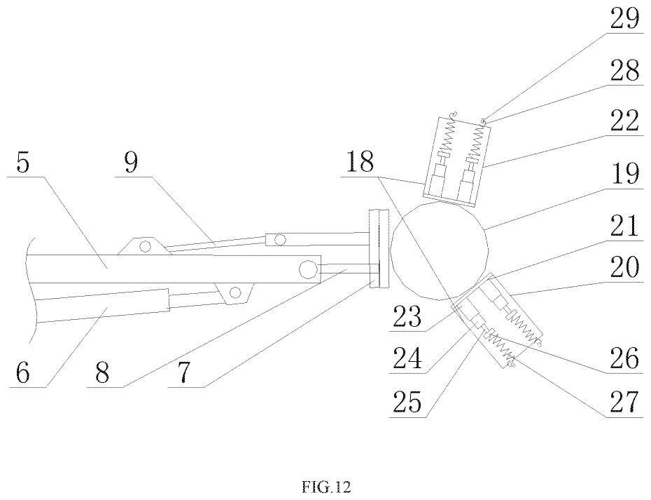

As shown in FIGS. 10 and 12, the PLC controller controls the expansion and contraction of the hydraulic cylinder, thus controlling the expansion and contraction of the first telescopic rod 23, the second telescopic rod 24 and the third telescopic rod 25, and then pushing the push rod 26 to extend or contract, so as to control an expansion and contraction of the tension spring 27 and the trimming ring 29. When the branches need to be pruned, the expansion is made, and when the branches need not to be pruned, the contraction is made. This can not only save occupied area, but also prevent others from being injured by accident, which is safe and has no hidden danger.

As shown in FIG. 5, the present invention provides another embodiment, a basic structure of which is the same as the above-mentioned structure, but a difference lies in that the connecting seat 7 is rotatably connected to a rotating shaft at an overhanging end of the overhanging arm 5, and the rotary power device includes a rotary gearbox which is connected to the overhanging arm 5 and is in power connection with a servo drive motor, a worm segment is arranged on a power output shaft of the rotary gearbox, and a power worm gear meshed with the worm segment is provided on the rotating shaft. The above-mentioned structure is not described in detail in the figure, and specifically, the power transmission structure similar to the main gearbox in the first embodiment mentioned above can be adopted, which will not be repeatedly described here.

The rotary blade of the trimming device can be replaced, and operators can select a suitable blade for operation according to different shapes and sizes of branches to be pruned, so that the device has a wider application range and strong practicability, and a new blade can be replaced once the blade is damaged, thus saving maintenance time and improving work efficiency.

According to the invention, two groups of trimming devices are arranged, which is with a high stability; the trimming device 18 includes a spiral bracket 21, which presents a higher strength; in addition, the spiral bracket 21 structure greatly reduces vibration from a constructor during operations so that the device is more stable; by arranging the first telescopic rod 23, the second telescopic rod 24, the third telescopic rod 25, the push rod 26 and the tension spring 27, an expansion/contraction ratio can be greatly improved; and with sleeves 22 of different lengths arranged, different sleeves 22 can be selected according to heights of different branches by adjusting the rotating shaft, and different rotating blades 33 can be replaced according to thicknesses of different branches, so as to realize a better pruning of the branches.

According to the invention, greening plants on both sides of an urban road or an expressway can be automatically pruned through the above mechanism, with advantages of high labor efficiency and large pruning range.

In the description of the present invention, it should be understood that the terms such as “an end”, “up front”, “end”, “length”, “width”, “inner”, “upper”, “other end”, “both ends”, “horizontal”, “coaxial”, “bottom”, “below” which indicate a orientation or positional relationship are based on the orientation or positional relationship shown in the drawings, and are merely for convenience of describing the present invention and simplifying the description, rather than indicate or imply that the device or element referred to must have a specific orientation, be configured and operated in a specific orientation, and thus cannot be understood as a limitation on the present invention.

In the present invention, unless otherwise specified and limited, the terms “providing”, “engaging”, “connecting”, “embedding” and “covering” should be understood in a broad sense, for example, it can be “fixedly connecting”, or “detachably connecting” or “integrally connecting”, or it can be “mechanically connecting” or “electrically connecting”, or it can be “directly connecting” or “indirectly connecting through an intermediate medium”, or it can be “communicating within two elements” or an interaction between two elements, unless otherwise explicitly defined. For those ordinary skilled in the art, the specific meanings of the above terms in this application can be understood according to specific situations.

The above is only preferred embodiments of the present invention, which does not limit a patent scope of the present invention thereby; and any equivalent structural transformation made by using the contents of the specification of the present invention, or directly or indirectly applied or attached in a technical field of other related product, is similarly included in the patent protection scope of the present invention.

1. An automatic walking garden trimmer, comprising a power locomotive (1), wherein a trimming device and a controller, the power locomotive (1) are rotatably connected with a turntable support (2) which is driven by a power device to rotate horizontally, a lower supporting arm (3) and a base cylinder (4) for driving the lower supporting arm (3) to swing are hinged to the turntable support (2), at least two overhanging arms (5) and an extension cylinder (6) for driving the overhanging arms (5) to swing and adjusting an overhanging distance are hinged to an end of the lower supporting arm (3), an end of the overhanging arm (5) is rotatably connected with a connecting seat (7) and a rotary power device for driving the connecting seat (7) to rotate, a plane formed by a rotating track of the connecting seat (7) is parallel or coincident with a plane formed by a swinging track of the overhanging arm (5), and a sphere (19) is connected to the connecting seat (7);
two groups of the trimming devices (18) are arranged on side surfaces of the sphere (19), the trimming device (18) comprises a spiral device (20) and a trimming ring (29), the spiral device (20) comprises a spiral bracket (21) and a sleeve (22) disposed on the spiral bracket (21), lengths of the sleeves (22) for the two groups of trimming devices (18) are different, the sleeves (22) are sequentially provided with two rows of first telescopic rods (23), second telescopic rods (24) and third telescopic rods (25) from inside to outside through a hydraulic cylinder, a push rod (26) is provided at an outer end of the third telescopic rod (25) with a tension spring (27) with a high hardness being provided at the outer end of the push rod (26), a hook (28) is provided at an outer end of the tension spring (27), the trimming ring (29) comprises a plurality of metal frames (30), and pin shaft mounting holes are defined at both ends and a midpoint of each metal frame (30), the pin shaft mounting holes in middle parts of every two metal frames (30) overlap and are installed into an X-shaped cross movable members through a pin shaft (31), ends of opposite sides of every two X-shaped cross movable members are connected by the pin shaft (31), a plurality of X-shaped cross movable members are connected into an annular telescopic trimming ring, with two hooks (28) being respectively fixedly connected with two metal frames (30) of one of the X-shaped cross movable members on the trimming ring (29);
a micromotor (32) is mounted below connecting pin shafts of every two X-shaped cross movable members in the trimming ring (29), and a detachable rotating blade (33) is mounted on an output shaft of the micromotor (32),
the power device, the base cylinder (4), the micromotor (32), the extension cylinder (6) and the rotary power device being all control by the controller.

2. The automatic walking garden trimmer according to claim 1, wherein a radius of the trimming ring (29) in a fully extended state is three times than that in a fully contracted state.

3. The automatic walking garden trimmer according to claim 1, wherein a maximum length of the rotating blade (33) is not more than half a length of the metal frame (30).

4. The automatic walking garden trimmer according to claim 1, wherein each of the two groups of trimming devices (18) is arranged to form an angle between 110° to 180° with a shaft in the middle of the sphere (19).

5. The automatic walking garden trimmer according to claim 1, wherein a rear end and a piston rod end of the extension cylinder (6) are respectively hinged at a front part of a front one (5) of two adjacent overhanging arms (5) and a middle forward part of the rear one (5) of the two adjacent overhanging arms (5).

6. The automatic walking garden trimmer according to claim 1, wherein the connecting seat (7) is rotatably connected to a rotating shaft at an overhanging end of the overhanging arm (5), and the rotary power device comprises a rotary gearbox which is connected to the overhanging arm (5) and is in power connection with a servo drive motor, a worm segment is arranged on a power output shaft of the rotary gearbox, and a power worm gear meshed with the worm segment is provided on the rotating shaft.

7. The automatic walking garden trimmer according to claim 1, wherein the rotary power device comprises a connecting rod (8) fixedly connected to the connecting seat (7), the connecting rod (8) is hinged with the overhanging end of the overhanging arm (5) through a hinge shaft, the overhanging arm (5) is hinged with a pulling cylinder, and a piston rod of the pulling cylinder is hinged with the connecting seat (7).

8. The automatic walking garden trimmer according to claim 1, wherein the turntable support (2) is rotatably connected to a main rotating shaft of a rear support seat of the power locomotive, and the power device comprises a main gearbox (11) connected to the rear support seat and driven by a main driving motor (10), a worm segment is provided on a power output shaft (17) of the main gearbox (11), and a worm gear meshed with the worm segment is provided on the main rotating shaft.

9. The automatic walking garden trimmer according to claim 1, wherein a brake plate (12) which is driven by an electric push rod and is able to abut against the turntable support (2) is provided on the rear support seat, and the electric push rod (34) and the main driving motor (10) are controlled by the controller.

10. The automatic walking garden trimmer according to claim 1, wherein the controller adopts a PLC controller for an automatic control.
